(19) United States
(12) Patent Application Publication
(10) Pub. No.: US 2019/0110581 A1
(43) Pub. Date: Apr. 18, 2019

(54) SPRAY PAINT CAN HARNESS

(71) Applicant: Alyssa COHEN, North Arlington, NJ (US)

(72) Inventor: Alyssa COHEN, North Arlington, NJ (US)

(21) Appl. No.: 16/091,190

(22) PCT Filed: Apr. 6, 2017
(86) PCT No.: PCT/US2017/026343

§ 371 Date: Oct. 4, 2018

Related U.S. Application Data
(60) Provisional application No. 62/319,372, filed on Apr. 7, 2016.

(51) Int. Cl. A45F 3/14; B05B 15/60

(52) U.S. Cl. CPC A45F 3/14; A45F 2003/146; B05B 15/60

(57) ABSTRACT

A spray paint can harness to be worn by a person to retain a plurality of spray paint cans. The harness includes a pair of shoulder straps that pass over the shoulders of the person and are joined together at the front and back of the person for stability. The shoulder straps are affixed, front and back, to a waist belt that surrounds the stomach of the person. A plurality of cylindrical receivers are detachably affixed to the shoulder straps and are positioned to be conveniently accessible to the person. The cylindrical receivers are adjustably positioned along the person. There may also be a pockets formed in the shoulder straps to retain objects, including a cell phone convenient to the person.

### FIELD OF THE INVENTION

The present invention relates to a harness for retaining objects in a position on a person to be conveniently accessed by the person and, more particularly, to a harness to be worn by a person that can hold a plurality of spray paint cans or other objects that are positioned within the ready reach of the person.

### BACKGROUND OF THE INVENTION

There are various uses for a harness that can retain certain objects on a person so that those objects are easily available and within ready access of the person. One use in particular is to affix a plurality of spray paint cans to the person so that each spray paint can is available and easily carried in a convenient location on the person.

The use of multiple spray paint cans carried by a person is typically carried out by artists that normally employ a variety of differing colors of the spray paint in order to produce an art object. For example, the art object may be a mural painted on the side of a building and, in creating that work of art, the artist may need to ascend and descend a ladder multiple times to select and use the various colors that are supplied in individual spray paint cans.

Accordingly, it would be advantageous to have a harness that the person could wear and which could accommodate a plurality of spray paint cans so that the person can carry multiple cans of differing colors simultaneously. It would be further advantageous if there were a harness that provided good support for the spray paint cans and yet have the spray paint cans located at convenient positions on the person to facilitate their access and use.

### SUMMARY OF THE INVENTION

Accordingly, the present invention relates to a harness for retaining objects in a position on a person to be conveniently accessed by the person. In the following description of the invention, the exemplary embodiment is described to be used with spray paint cans as the objects to be retained on the person, however, it will be seen that the same harness could be used for objects other than spray paint cans and be equally useful.

As such, the present invention relates to a harness wearable by a person, such as an artist, for retaining a plurality of spray paint cans on that person at locations that are convenient to the person to retrieve and use the individual spray paint cans.

The harness is comprised of a pair of shoulder straps that pass over the shoulders of the person. Each shoulder strap is comprised of a front strap portion the rests along the front of the person and a rear strap portion that rests along the rear or back of the person when the harness is being worn by the person. The rear strap portions can be joined together by an adjustable rear strap along the back of the person to hold the rear strap portions of the shoulder straps in a stable position.

A chest strap can secure the front strap portions of the shoulder straps together at the front or stomach of the person. A waist belt encircles the waist or stomach of a person. Both the chest strap and rear strap can be adjustable as to their lengths and have snap connectors to connect to the front and rear strap portions of the shoulder straps to facilitate the donning or removing of the harness from the person. Both the front strap portions and rear strap portions of the shoulder straps are affixed to the waist belt.

There is a plurality of cylindrical receivers that are adapted to receive an object such as a cylindrical spray paint can and are dimensioned to snugly retain the cylindrical spray paint can. The cylindrical receivers are affixed to the shoulder straps at locations that are convenient to the person to access in retrieving or returning a spray paint can to a cylindrical receiver. In the exemplary embodiment, the cylindrical receivers can be constructed of a heavy or reinforced fabric so that the cylindrical receivers retain their lateral circular cross section even when there is no spray paint can retained in a cylindrical receiver.

The cylindrical receivers are affixed to the front and rear strap portions of the shoulder straps by means of cross straps that are adjustable in length and have snap connectors that allow the cylindrical receivers to be easily detached and removed from the harness.

As a further feature of the present invention, the front strap portion of one shoulder strap may include a pocket formed therein that has a zipper closure and can be used to store caps from the spray paint cans or other items. The front strap portion of the other shoulder strap may have a pocket formed therein dimensioned to receive and retain a cell phone so that it is readily available to the person.

These and other features and advantages of the present invention will become more readily apparent during the following detailed description taken in conjunction with the drawings herein.

### BRIEF DESCRIPTION OF THE DRAWINGS

FIG. 1 is a front view of the harness of the present invention being worn by a user;

FIG. 2 is side view of the harness of FIG. 1 being worn by a user; and

FIG. 3 is rear view of the harness of FIG. 1 being worn by a user.

### DETAILED DESCRIPTION OF THE INVENTION

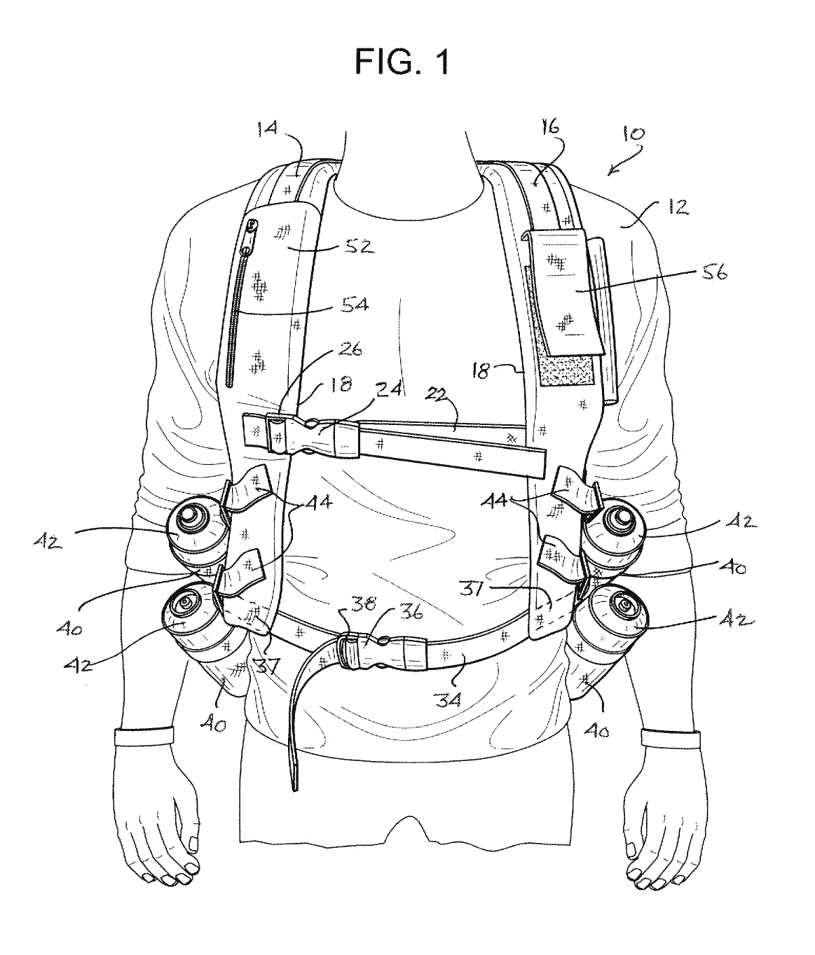

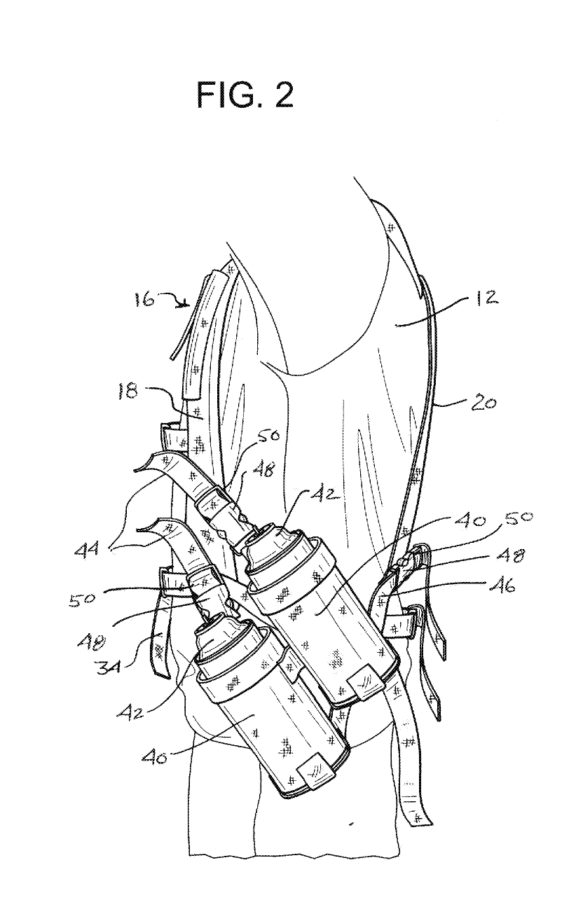

Referring now to FIGS. 1-3, there is shown a front view, a side view and a rear view of the harness 10 of the present invention being worn by a person 12. As can be seen, the harness 10 comprises a pair of shoulder straps 14, 16 that pass over the shoulders of the person 12 and for the present description, the shoulder straps 14, 16 will be referred to as comprising front strap portions 18 and rear strap portions 20, it being understood that the shoulder straps 14, 16 are, in the exemplary embodiment, simply two unbroken, unitary straps.

Looking at FIG. 1, there is also a chest strap 22 that crosses the chest of the person 12 and provides an attachment between the two front strap portions 18 of the shoulder straps 14, 16. The chest strap 22 includes a snap connector 24 that allows the person 12 to readily attach and detach the chest strap 22 from the shoulder straps 14 and 16 and includes a strap adjuster 26 that allows the person to adjust the length of the chest strap 22 to suit the comfort of the person 12. The presence of the snap connector 24 allows the harness 10 to be easily and quickly donned and removed from the person 12.

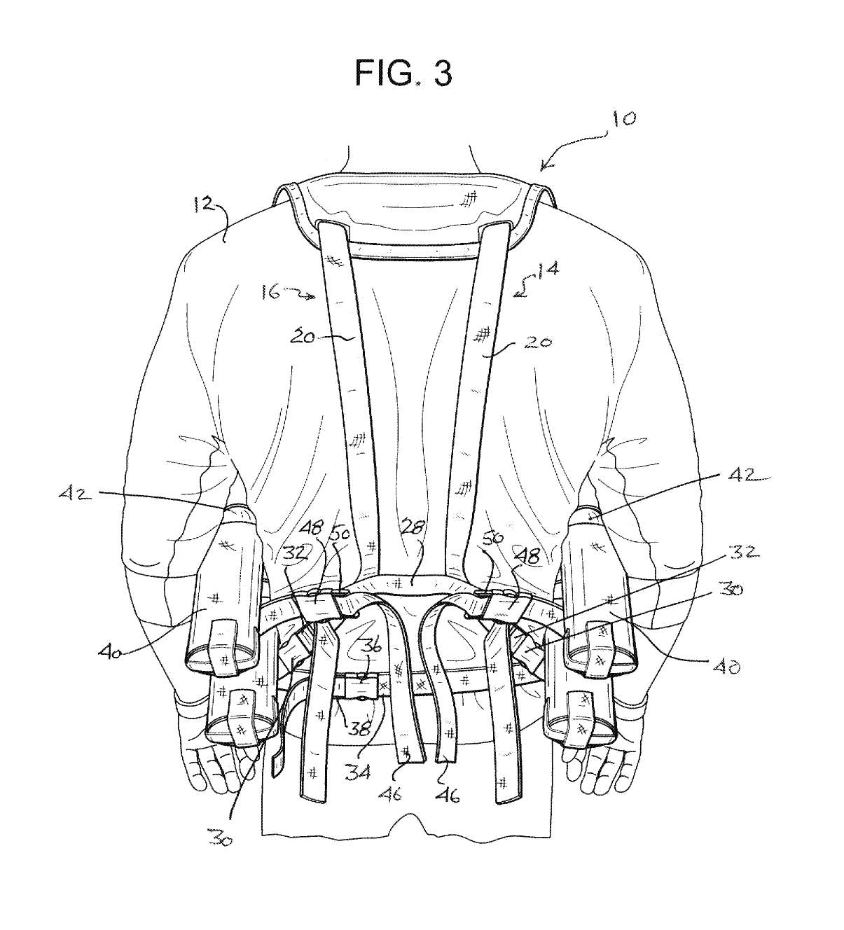

As seen in FIG. 3, there is also a rear strap 28 that lies along the back of the person 12 and, again, may include a snap connector 30 that allows the person 12 to readily attach and detach the rear strap 28 from the shoulder straps 14, 16 and includes a strap adjuster 32 that allows the person to adjust the length of the rear strap 28 to suit the comfort of the person 12.

A waist belt 34, seen in all three Figs. encircles the person 12 and has a snap connector 36 at the front of the person 12 and passes through loops 37 at the bottoms of the front and rear strap portions 18, 20 of the shoulder straps 14, 16. Again, the snap connector 32 includes a strap adjuster 38 to allow the person 12 to adjust the length of the waist belt 32.

There are a plurality of receivers 40 that are positioned about the person 12 and which are adapted to hold a cylindrical or other shape object within the convenient reach of the person 12 so that the location of a receiver 40 is strategically placed to allow ease of access and use by a person 12 desiring use of the objects.

In the exemplary embodiment, the cylindrical objects are spray paint cans 42 and the receivers 40 are cylindrically shaped and dimensioned to accept a spray paint can 42 to rest within each receiver 40 with sufficient friction to remain positioned therein until and unless the person 12 deliberately withdraws a spray paint can 42 from a receiver 40. The receiver 40 can be made of a sufficiently strong, semi-pliable material such that the lateral cross section of a receiver remains circular even when a spray paint can 42 has been removed from a receiver 40.

The receivers 40 are detachably affixed to the shoulder straps 14, 16 by means of front and rear cross straps 44, 46 extending outwardly from both sides of a receiver 40. The front cross straps 44 are attached to the front strap portions 18 of the shoulder straps 14, 16 and the rear cross straps 46 are affixed to the rear strap portions 20 of the shoulder straps 14, 16. In each instance, in the exemplary embodiment, the connections of the front and rear cross straps 44, 46 is accomplished by the use of snap connectors 48 that include strap adjusters 50 to allow the length of the front and rear cross straps 44, 46 to be adjusted by the user.

In the exemplary embodiment, there are additional desirable features of the harness 10 and shown in FIG. 1. In the shoulder strap 14 there can be a pocket 52 formed therein with a closure such as a zipper 54 to open and close that pocket 52. In addition, in the shoulder strap 16, there can be a suitable pocket 56 for retaining a cell phone, not shown, that places the cell phone in a position convenient for the person 12.

Those skilled in the art will readily recognize numerous adaptations and modifications which can be made to the harness for retaining objects of the present invention which will result in an improved harness, yet all of which will fall within the scope and spirit of the present invention as defined in the following claims. Accordingly, the invention is to be limited only by the following claims and their equivalents.

What is claimed is:

1. A harness wearable by a person for retaining a plurality of objects, the harness comprising a pair of shoulder straps adapted to be joined to each other at the front of a person, and a waist belt encircling a waist of a person, the shoulder straps passing over the shoulders of a person and being affixed to the waist belt, a plurality of receivers, each receiver adapted to retain an object, wherein each of the receivers is detachably affixed to the shoulder straps.

2. The harness of claim 1 wherein the receivers are cylindrical and are adapted to retain a spray paint can.

3. The harness of claim 1 wherein the shoulder straps both have a front strap portion located along the front of a person and a rear strap portion located along the rear of a person and wherein at least one cylindrical receiver is affixed to the front strap portion and the rear strap portion.

4. The harness of claim 3 wherein the at least one cylindrical receiver is detachably affixed to the front and rear strap portions.

5. The harness of claim 4 wherein the at least one cylindrical receiver is detachably affixed to the front and rear strap portions by mean of front and rear cross straps having snap connectors provided therein.

6. The harness of claim 5 wherein the front and rear cross straps have a length that is adjustable.

7. The harness of claim 1 wherein one of the shoulder straps has a pocket formed therein with an openable closure.

8. The harness of claim 7 wherein the openable closure is a zipper.

9. The harness of claim 1 wherein one of the shoulder straps has a pocket formed therein dimensioned to receive a cell phone.

10. The harness of claim 1 further including a rear strap that detachably connects the rear strap portions together.

11. The harness of claim 1 further including a chest strap that detachably connects the front strap portions together.

12. A harness wearable by a person containing a plurality of cylindrical objects, the harness comprising a pair of shoulder straps adapted to be joined to each other at the front of a person, and a waist belt encircling a person, the shoulder straps passing over the shoulders of a person and being affixed to the waist belt, a plurality of cylindrical receivers detachably affixed to the shoulder straps, at least one of the cylindrical receivers having a cylindrical object contained therein and positioned within easy reach of a person.

13. The harness of claim 12 wherein the at least one cylindrical receiver is removably attached to the shoulder straps.

14. The harness of claim 12 wherein the cylindrical object is a spray paint can.

15. The harness of claim 13 wherein the at least one cylindrical receiver comprises a plurality of cylindrical receivers, each containing a cylindrical object.

16. The harness of claim 15 wherein the plurality of cylindrical receivers contains a spray paint can.
